(19) United States
(12) Patent Application Publication
(10) Pub. No.: US 2016/0323570 A1
(43) Pub. Date: Nov. 3, 2016

(54) THREE-DIMENSIONAL IMAGE DISPLAY DEVICE AND DRIVING METHOD THEREOF

(71) Applicant: Samsung Display Co., Ltd., Yongin-si (KR)

(72) Inventors: Tae Hyung KIM, Anyang-si (KR); Kang-Min KIM, Hwaseong-si (KR); Jeong Min SUNG, Seoul (KR); Hyung Woo YIM, Goyang-si (KR); Hyeon Yong JANG, Hwaseong-si (KR)

(21) Appl. No.: 15/081,471

(22) Filed: Mar. 25, 2016

(30) Foreign Application Priority Data
Apr. 28, 2015 (KR) 10-2015-0060001

(51) Int. Cl. H04N 13/04; H04N 13/00

(52) U.S. Cl. CPC H04N 13/0497; H04N 13/0007; H04N 13/0422; H04N 13/0404; H04N 13/0425; H04N 13/0484

(57) ABSTRACT

There is provided a three-dimensional image display device, including: a display panel including a plurality of signal lines and a plurality of pixels connected to the plurality of signal lines; a viewpoint divider configured to divide an image displayed by the display panel into a plurality of viewpoints; a parameter storage unit configured to store parameters for an alignment between the display panel and the viewpoint divider; an image processor configured to calculate a rendering pitch according to the alignment between the display panel and the viewpoint divider by using the parameters stored in the parameter storage unit and generate an image signal to perform pixel mapping according to the rendering pitch; and a display panel driver configured to receive the image signal to drive the display panel.

### CROSS-REFERENCE TO RELATED APPLICATION

This application claims priority to and the benefit of Korean Patent Application No. 10-2015-0060001 filed in the Korean Intellectual Property Office on Apr. 28, 2015, the entire contents of which are incorporated herein by reference.

### BACKGROUND

(a) Field

The present disclosure relates to a three-dimensional image display device and a driving method thereof, and more particularly, to a three-dimensional image display device and a driving method thereof capable of compensating for misalignment between a display panel and a viewpoint divider.

(b) Description of the Related Art

Generally, a stereoscopic image in a three-dimensional (3D) display is implemented based on a principle of stereo vision by two eyes, called binocular disparity. Binocular disparity between two eyes occurs due to the two eyes being spaced apart from each other, as much as about 65 mm, and is the basis for generating a three-dimensional effect. Particularly, the left and right eyes each see different 2D images, and when the two images are transferred to the brain through the retinas, the brain accurately fuses the two images with each other to reproduce original depth and reality of the 3D image. This ability is generally referred to as stereography.

A three-dimensional image display device that uses binocular disparity may be classified into a stereoscopic polarization type, a stereoscopic time division type, an autostereoscopic parallax-barrier type, a lenticular type, and a blinking light type, depending on whether an observer wears separate glasses.

In the autostereoscopic three-dimensional image display device, a viewpoint divider that divides a left-eye image and a right-eye image, like the lenticular lens layer or the parallax-barrier, is disposed on the display panel. The autostereoscopic three-dimensional image display device has an advantage in that an observer does not need to use special glasses to see the stereoscopic image on a screen.

However, a misalignment in which the display panel and the viewpoint divider are not accurately bonded to each other, as designed, may occur during the bonding process. The misalignment may cause a crosstalk in the three-dimensional image display device.

The above information disclosed in this Background section is only for enhancement of understanding of the background of the disclosure and therefore may contain information that does not form the prior art that is already known in this country to a person of ordinary skill in the art.

### SUMMARY

The present disclosure provides a three-dimensional image display device and a driving method thereof having advantages of compensating for a misalignment between a display panel and a viewpoint divider.

An exemplary embodiment of the present disclosure provides a three-dimensional image display device, including: a display panel including a plurality of signal lines and a plurality of pixels connected to the plurality of signal lines; a viewpoint divider configured to divide an image displayed by the display panel into a plurality of viewpoints; a parameter storage unit configured to store parameters for an alignment between the display panel and the viewpoint divider; an image processor configured to calculate a rendering pitch according to the alignment between the display panel and the viewpoint divider by using the parameters stored in the parameter storage unit and generate an image signal to perform pixel mapping according to the rendering pitch; and a display panel driver configured to receive the image signal to drive the display panel.

The parameter may include a design parameter representing a design value of the alignment between display panel and the viewpoint divider and a measurement parameter representing a measurement value of the align between the display panel and the viewpoint divider.

The design parameter may include at least one of a viewpoint division pitch of the viewpoint divider, a bonding gap between the display panel and the viewpoint divider, a viewpoint division slope of a lenticular lens or an opening included in the viewpoint divider, an optimal viewing distance, and the rendering pitch.

The measurement parameter may include a bonded offset representing a movement of the viewpoint divider in an x-axis or y-axis direction with respect to the display panel.

The measurement parameter may further include a viewpoint division slope of a lenticular lens or an opening included in the viewpoint divider that represents a rotation of the viewpoint divider around a z-axis with respect to the display panel.

The measurement parameter may further include a bonding gap between the display panel and the viewpoint divider.

The display panel may be divided into a plurality of areas and the measurement parameter may include local measurement parameters measured for each of the plurality of areas.

The image processor may define the local measurement parameters for each of the plurality of areas as central values of each area and interpolate between the central values to calculate additional parameters.

The parameter storage unit may be prepared as a storage medium of an EEPROM and may be integrated on the display panel along with the display panel driver.

The parameter storage unit may be prepared as a storage medium of an EEPROM and may be mounted on a printed circuit board (PCB) along with the display panel driver.

Another exemplary embodiment of the present disclosure provides a driving method of a three-dimensional image display device including a display panel including a plurality of signal lines and a plurality of pixels connected to the plurality of signal lines and a viewpoint divider dividing an image displayed by the display panel into a plurality of viewpoints, the driving method including: calculating a rendering pitch according to an alignment between the display panel and the viewpoint divider using parameters for the alignment between the display panel and the viewpoint divider; generating an image signal to perform pixel mapping according to the rendering pitch; and driving the display panel according to the image signal.

The parameter may include a design parameter representing a design value of the alignment between the display panel and the viewpoint divider and a measurement parameter representing a measurement value of the alignment between the display panel and the viewpoint divider.

The design parameter may include at least one of a viewpoint division pitch of the viewpoint divider, a bonding gap between the display panel and the viewpoint divider, a viewpoint division slope of a lenticular lens or an opening included in the viewpoint divider, an optimal viewing distance, and the rendering pitch.

The measurement parameter may include a bonded offset representing a movement of the viewpoint divider in an x-axis or y-axis direction with respect to the display panel.

The measurement parameter may further include a viewpoint division slope of a lenticular lens or an opening included in the viewpoint divider that represents a rotation of the viewpoint divider around a z-axis with respect to the display panel.

The measurement parameter may further include a bonding gap between the display panel and the viewpoint divider.

The display panel may be divided into a plurality of areas and the measurement parameter may include local measurement parameters measured for each of the plurality of areas.

The driving method may further include: defining the local measurement parameters for each of the plurality of areas as central values of each area and interpolating between the central values to calculate additional parameters.

In accordance with the three-dimensional image display device according to an exemplary embodiment of the present disclosure, it is possible to compensate for the misalignment between the display panel and the viewpoint divider and remove the crosstalk due to the misalignment between the display panel and the viewpoint divider.

Further, it is possible to increase the permissible error of the optical bonding between the display panel and the viewpoint divider and improve the yield of the three-dimensional image display device by compensating for the misalignment occurring while the display panel is bonded to the viewpoint divider by the driving method of the three-dimensional image display device.

In addition, it is possible to remove the additional compensation circuit in the driving board for displaying the three-dimensional image by storing the parameters for the alignment between the display panel and the viewpoint divider in the storage unit and performing the actual compensation processing in the image processing application.

### BRIEF DESCRIPTION OF THE DRAWINGS

FIG. 1 is a perspective view schematically illustrating a three-dimensional image display device according to an exemplary embodiment of the present disclosure.

FIG. 2 is a side perspective view schematically illustrating the three-dimensional image display device according to an exemplary embodiment of the present disclosure.

FIGS. 3, 4 and 5 are diagrams illustrating a viewpoint divider of the three-dimensional image display device according to an exemplary embodiment of the present disclosure and a viewpoint by the viewpoint divider.

FIGS. 6 and 7 are exemplified diagrams illustrating an example of misalignment between a display panel and a viewpoint divider of the three-dimensional image display device according to an exemplary embodiment of the present disclosure.

FIG. 8 is an exemplified diagram for describing an example of parameters stored in a parameter storage unit of the three-dimensional image display device according to an exemplary embodiment of the present disclosure.

FIGS. 9 and 10 are exemplified diagrams for describing a process of compensating for a slope of the viewpoint divider of the three-dimensional image display device according to an exemplary embodiment of the present disclosure.

FIG. 11 is an exemplified diagram for describing a process of compensating for a bonding gap between the display panel and the viewpoint divider of the three-dimensional image display device according to an exemplary embodiment of the present disclosure.

FIG. 12 is an exemplified diagram for describing another example of parameters stored in the parameter storage unit of the three-dimensional image display device according to an exemplary embodiment of the present disclosure.

### DETAILED DESCRIPTION OF THE EMBODIMENTS

Hereinafter, the present system and method are described more fully with reference to the accompanying drawings in which exemplary embodiments of the present system and method are shown. As those skilled in the art would realize, the described embodiments may be modified in various different ways, all without departing from the spirit or scope of the present disclosure.

Further, in exemplary embodiments, since like reference numerals designate like elements having the same configuration, a first exemplary embodiment is representatively described, and in other exemplary embodiments, only a configuration different from the first exemplary embodiment is described.

Accordingly, the drawings and description are to be regarded as illustrative in nature and not restrictive. Like reference numerals designate like elements throughout the specification.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and its variations, such as “comprises” or “comprising”, imply the inclusion of stated elements but not the exclusion of any other elements.

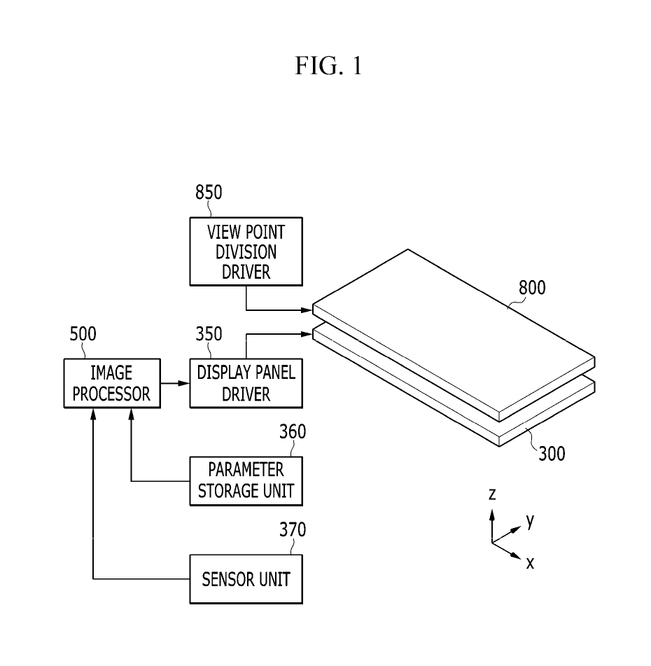

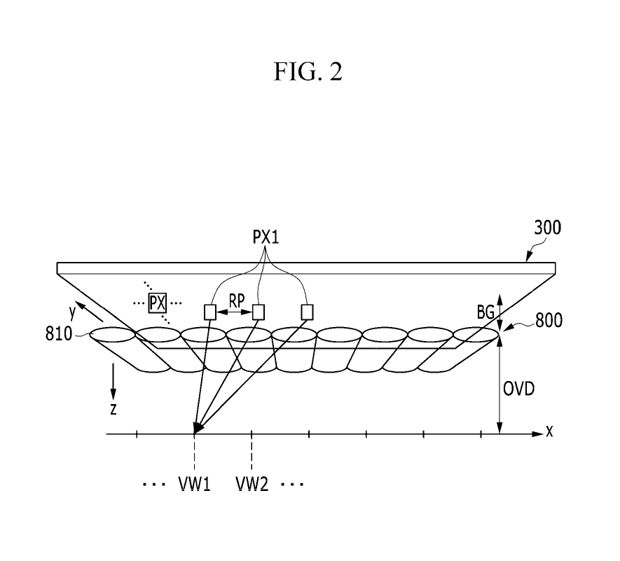

First, a three-dimensional image display device according to an exemplary embodiment of the present disclosure is described with reference to FIGS. 1 to 2.

FIG. 1 is a perspective view schematically illustrating a three-dimensional image display device according to an exemplary embodiment of the present disclosure. FIG. 2 is a side perspective view schematically illustrating the three-dimensional image display device according to an exemplary embodiment of the present disclosure.

Referring to FIGS. 1 and 2, the three-dimensional image display device includes a display panel 300, a display panel driver 350, a parameter storage unit 360, a sensor unit 370, an image processor 500, a viewpoint divider 800, and a viewpoint division driver 850.

The display panel 300 displays an image and may be any one of the display panels that are generally included in various display devices, such as a plasma display panel (PDP), a liquid crystal display, and an organic light emitting display.

When viewing the display panel 300 as an equivalent circuit, the display panel 300 includes a plurality of signal lines and a plurality of pixels PXs that are connected to the plurality of signal lines. The plurality of pixels PXs may be arranged in approximately a matrix form. As illustrated in FIG. 2, a row direction is represented by an x-axis direction, and a column direction is represented by a y-axis direction. Each pixel PX may include a switching element (not illustrated), like a thin film transistor, connected to a signal line and a pixel electrode (not illustrated) connected thereto. The signal line includes a plurality of gate lines through which gate signals (referred to as “scanning signal”) are transferred and a plurality of data lines through which a data voltage is transferred.

A plurality of the pixels PXs may each uniquely display one of primary colors so that a spatial sum of the combined display of the primary colors achieves a desired color (i.e., spatial division), or the plurality of pixels PXs may each alternately display the primary colors over time so that the temporal sum of the displayed colors achieves a desired color (i.e., temporal division). An example of the primary colors may include three primary colors, such as red (R), green (G), and blue (B). A set of pixels PXs displaying different primary colors may form one dot together. One dot is a display unit of a three-dimensional image and may display a white image. The pixels PXs of one pixel array may represent the same primary colors but are not limited thereto. For example, pixels PXs arranged in a direction forming a diagonal of a predetermined angle may also represent the same primary colors.

The display panel driver 350 transfers various driving signals, such as a gate signal and a data signal, to the display panel 300 to drive the display panel 300. The display panel driver 350 may be directly mounted on the display panel 300 in a single-IC chip form, mounted on a flexible, printed circuit film, attached to the display panel 300 in a tape-carrier package (TCP) form, or mounted on a separate printed circuit board (PCB).

The parameter storage unit 360 stores parameters for the viewpoint divider 800. In particular, the parameter storage unit 360 stores parameters for the alignment between the display panel 300 with the viewpoint divider 800 and transfers the stored parameters to the image processor 500. A detailed description of the parameters stored in the parameter storage unit 360 is described below. The parameter storage unit 360 may be prepared as a storage medium, like an electrically erasable programmable read-only memory (EEPROM), and may be integrated on the display panel 300 along with the display panel driver 350, mounted on the flexible, printed circuit film, attached to the display panel 300 in the TCP form, or mounted on the separate printed circuit board (PCB).

The sensor unit 370 is an eye tracking sensor that senses a position and a distance of a user's eyes. The sensor unit 370 may sense central positions of the user's pupils, a distance (or distance between centers of two pupils) between the user's two pupils, the distance from the three-dimensional image display device to the user's eyes, and so on. The data sensed by the sensor unit 370 is transferred to the image processor 500.

The viewpoint divider 800 divides the light of an image displayed by a pixel PX of the display panel 300 and transfers the divided light to viewpoints VW1, VW2, . . . corresponding to each pixel PX. A distance from the three-dimensional image display device to a point at which an optimal three-dimensional image may be viewed is called an optimal viewing distance OVD. A position in the X-axis direction of the point at which the light of the image displayed by each pixel PX in the optimal viewing distance OVD arrives may be referred to as a viewpoint. According to an exemplary embodiment of the present disclosure, each pixel PX of the display panel 300 corresponds to any one of the viewpoints VW1, VW2, . . . and each pixel PX may transfer the light of the image to the corresponding viewpoints VW1, VW2, . . . through the viewpoint divider 800. A user views a different image at different viewpoints with each eye and thus may feel a sense of depth, that is, a three-dimensional sense.

As illustrated in FIG. 2, when an image displayed by first pixels PX1 is viewed at a first viewpoint VW1, the light of the image displayed by each of the first pixels PX1 may reach the first viewpoint VW1 through the viewpoint divider 800. An interval between adjacent pixels (for example, PX1) that transfer the light of the image to one viewpoint (for example, VW1) positioned at the optimal viewing distance OVD through the viewpoint divider 800 is referred to as a rendering pitch RP. Further, an interval between the display panel 300 and the viewpoint divider 800 is referred to as a bonding gap (BG). When the optimal viewing distance OVD is constant, a size of the rendering pitch RP may be changed depending on a size of the bonding gap BG1.

The viewpoint division driver 850 is connected to the viewpoint divider 800 to generate a driving signal for driving the viewpoint divider 800.

The viewpoint divider 800 may be manufactured in a film formed with a pattern of the lenticular lens or the parallax barrier. In some cases, the viewpoint division driver 850 may be omitted.

The image processor 500 generates an image signal and transfers the generated image signal to the display panel driver 350. In this case, the image processor 500 generates the image signal based on parameters transferred from the parameter storage unit 360 and sensing data transferred from the sensor unit 370. That is, the image processor 500 calculates the rendering pitch RP according to the alignment between the display panel 300 and the viewpoint divider 800 using parameters for the alignment between the display panel 300 and the viewpoint divider 800 and generates the image signal to perform pixel mapping according to the rendering pitch RP. Further, the image processor 500 uses the sensing data of the sensor unit 370 to generate an image signal and perform the pixel mapping corresponding to the user's viewpoint. The image processor 500 may include driving hardware for generating the image signal and an image processing application for calculating the rendering pitch RP and performing the pixel mapping. The pixel mapping includes generating and matching the image data of each pixel to display the same viewpoint image in the pixels PXs corresponding to each viewpoint VW1, VW2, . . . . For example, in FIG. 2, the pixel mapping may be performed to display the image of the first viewpoint VW1 in the first pixels PX1 corresponding to the first viewpoint VW1.

The image processor 500 uses the parameters for the alignment between the display panel 300 and the viewpoint divider 800 to calculate the rendering pitch RP and generates the image signal to perform the pixel mapping according to the rendering pitch RP, thereby compensating for the misalignment between the display panel 300 and the viewpoint divider 800 and removing the crosstalk due to the misalignment.

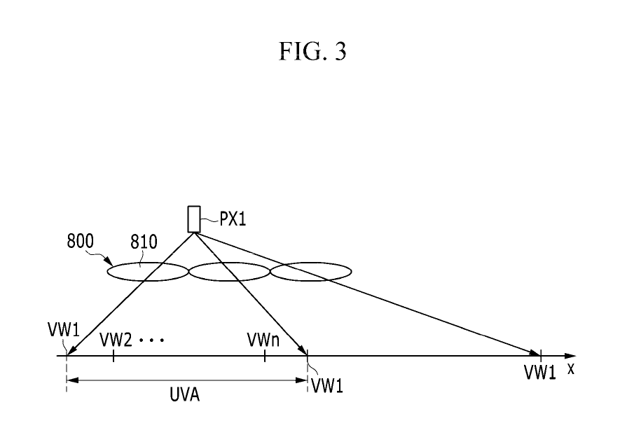

Hereinafter, the viewpoint by the viewpoint divider 800 is described with reference to the FIGS. 3 to 5.

FIGS. 3 to 5 are diagrams illustrating a viewpoint divider of the three-dimensional image display device according to an exemplary embodiment of the present disclosure and a viewpoint by the viewpoint divider.

Referring to FIGS. 3 to 5, the image displayed by the display panel 300 may reach any one of the viewpoints VW1 to VWn (n is a natural number) of a unit view area UVA having a constant viewing angle through the viewpoint divider 800. That is, the viewpoints VW1 to VWn exist in any one of the unit view areas UVAs and a corresponding viewpoint of each pixel PX may be allocated depending on a position at which the light of the image arrives in one unit view area UVA. The unit view area UVA may be periodically repeated along the x-axis direction at the optimal viewing distance OVD, and an order of the viewpoints VW1 to VWn in each unit view area UVA may be constant.

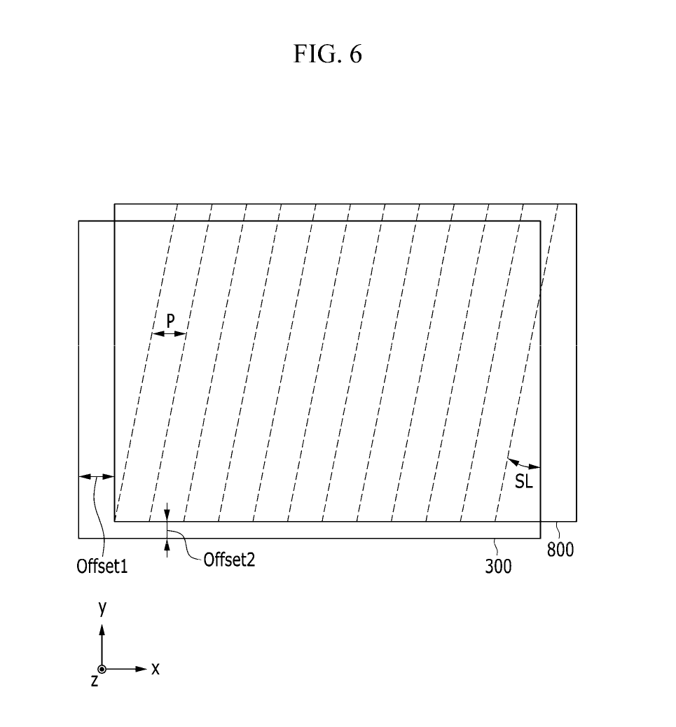

As illustrated in FIG. 3, the viewpoint divider 800 according to an exemplary embodiment of the present disclosure may include a plurality of lenticular lenses 810 arranged in one direction. Each lenticular lens 810 may extend long in one direction. A color arrangement of adjacent pixel rows corresponding to each lenticular lens 810 may be different. That is, the primary colors represented by the first pixel PX of the adjacent pixel rows corresponding to each lenticular lens 810 may be different. An extending direction of each lenticular lens 810 may be inclined to form an acute angle with the y-axis direction, which is a column direction (see FIG. 6), and may substantially be parallel with the y-axis direction.

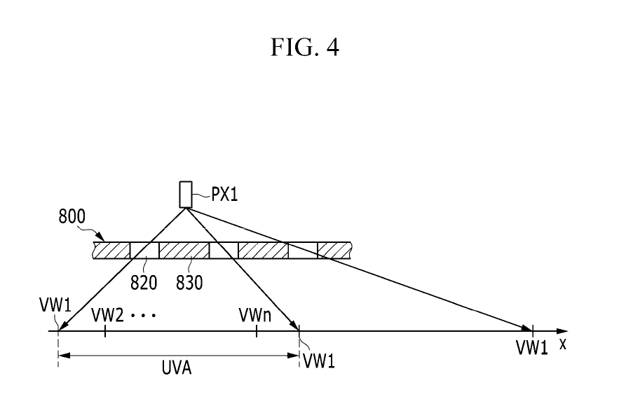

As illustrated in FIG. 4, the viewpoint divider 800 according to an exemplary embodiment of the present disclosure may include a parallax barrier having a plurality of openings 820 and a light blocking unit 830. An arrangement direction of the openings 820, which are arranged in a row, may be inclined to form an acute angle with the y-axis direction, which is the column direction (see FIG. 6), like the extending direction of the lens, and may be substantially parallel with the y-axis direction. When the viewpoint divider 800 includes the lenticular lens 810 instead of the parallax barrier, the extending direction of the lenticular lens may correspond to the arrangement direction of the opening 820 corresponding to one viewpoint.

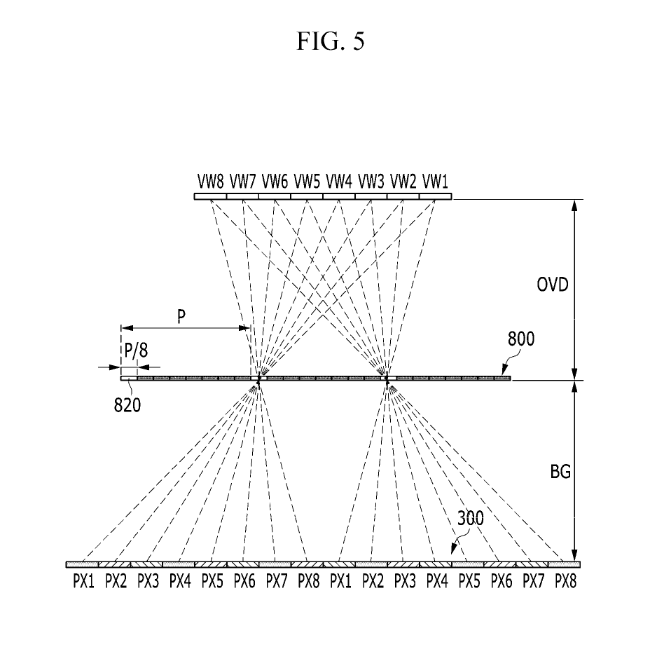

FIG. 5 illustrates an example in which the viewpoint divider 800 includes the parallax barrier, and eight viewpoints VW1, VW2, . . . , VW8 are positioned at the optimal viewing distance OVD. According to the exemplary embodiment of FIG. 5, the display panel 300 may include first to eighth pixels PX1, PX2, . . . , PX8 that display the three-dimensional images each corresponding to first to eighth viewpoints VW1, VW2, . . . , VW8. The first to eighth pixels PX1, PX2, . . . , PX8 may be periodically arranged in each pixel row. The images displayed by the first to eighth pixels PX1, PX2, . . . , PX8 may be viewed at each of the corresponding first to eighth viewpoints VW1, VW2, . . . , VW8 through the opening 820 (or lenticular lens 810) of the parallax barrier of the viewpoint divider 800. Several conditions, such as the width of the opening 820 (or lenticular lens 810), the arrangement direction of the opening 820 (or extending direction of the lenticular lens 810), the optimal viewing distance OVD, and the bonding gap G1 between the display panel 300 and the viewpoint divider 800, may be appropriately controlled. When the viewpoint divider 800 includes the parallax barrier, the width of each opening 820 may be approximately ⅛ of a viewpoint division pitch P of the opening 820. However, the width of the opening 820 is not limited thereto.

A unit of the viewpoint divider 800 corresponding to a set of first to eighth pixels PX1, PX2, . . . , PX8 corresponding to each viewpoint of the unit view area UVA is referred to as the viewpoint division unit. The viewpoint divider 800 may include a plurality of viewpoint division units. For example, when the viewpoint divider 800 is the lenticular lens 810, each lenticular lens 810 may correspond to the viewpoint division unit, and when the viewpoint divider 800 is the parallax barrier, each opening 820 arranged in a row may correspond to the viewpoint division unit. The interval between adjacent viewpoint division units is called the viewpoint division pitch P. That is, the interval between adjacent lenticular lenses 810 or the interval between adjacent openings 820 may be called the viewpoint division pitch P.

Hereinafter, the misalignment between the display panel 300 and the viewpoint divider 800 is described, and a method for compensating for misalignment between the display panel 300 and the viewpoint divider 800 using the parameters for the alignment between the display panel 300 and the viewpoint divider 800 is described.

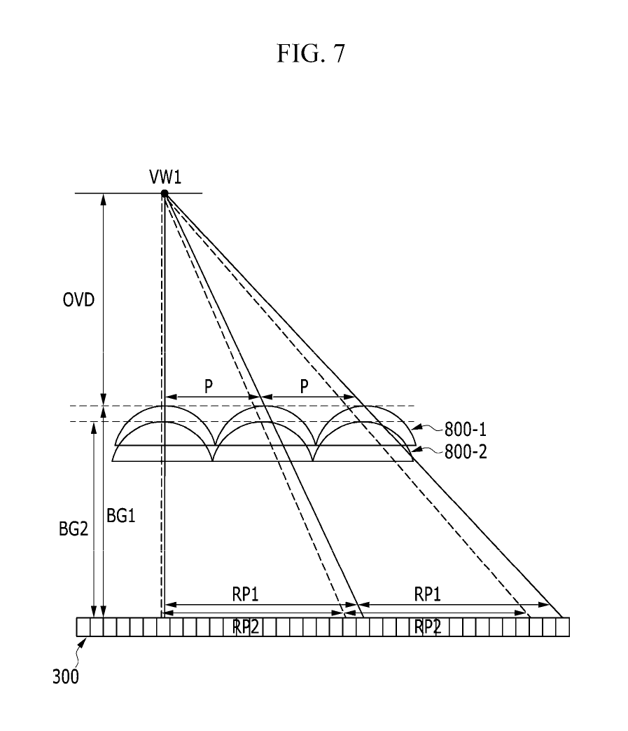

FIGS. 6 and 7 are exemplified diagrams illustrating an example of the misalignment between the display panel and the viewpoint divider of the three-dimensional image display device according to an exemplary embodiment of the present disclosure.

Because accurately bonding the display panel 300 and the viewpoint divider 800 may be challenging during manufacture, misalignment due to a bonding error may occur between the display panel 300 and the viewpoint divider 800.

As illustrated in FIG. 6, the bonding error between the display panel 300 and the viewpoint divider 800 includes a moving error of the viewpoint divider 800 in the x-axis and y-axis directions and a rotation error of the viewpoint divider 800 with respect to a z-axis. That is, the viewpoint divider 800 may be bonded to the display panel 300 while having an error as much as offsets offset1 and offset2 in the x-axis and y-axis directions with respect to the display panel 300, or the viewpoint divider 800 may be bonded to the display panel 300 while being twisted at a predetermined angle clockwise or counterclockwise with respect to the z-axis.

When the moving error of the viewpoint divider 800 in the x-axis direction or the y-axis direction occurs, the lenticular lens 810 or the opening 820 of the parallax barrier of the viewpoint divider 800 moves in the x-axis direction, and the pixel displaying the three-dimensional image corresponding to each viewpoint moves in the x-axis direction. When the display panel 300 displays the three-dimensional image without considering the moving error in the x-axis direction or the y-axis direction, a crosstalk phenomenon in which the left-eye image and the right-eye image are both seen by the same eye may occur.

When the rotation error of the viewpoint divider 800 occurs with respect to the z-axis, a slope SL (hereinafter, SL is referred to as ‘viewpoint division slope’) of the lenticular lens 810 or the opening 820 of the parallax barrier of the viewpoint divider 800 is changed with respect to the y-axis. The viewpoint division pitch P is the interval between adjacent lenticular lenses 810 in the x-axis direction or the interval between adjacent openings 820 of the parallax barrier, and therefore, the viewpoint division pitch P is also changed according to the change in the viewpoint division slope SL. When the display panel 300 displays the three-dimensional image without considering the change in the viewpoint division pitch P, a crosstalk phenomenon in which the left-eye image and the right-eye image are both seen by the same eye may occur.

As illustrated in FIG. 7, the bonding error between the display panel 300 and the viewpoint divider 800 includes an error of the bonding gap BG between the display panel 300 and the viewpoint divider 800. If the viewpoint division pitch P of the viewpoint divider 800 is constant, when the bonding gap BG is formed differently from the design value at the time of bonding between the display panel 300 and the viewpoint divider 800, the rendering pitch RP is also different from the design value. For example, FIG. 7 illustrates a first rendering pitch RP1 and a second rendering pitch RP2. The first rendering pitch is the designed interval between the pixels transferring the light of the image to the first viewpoint VW1 through a viewpoint divider 800-1 bonded by a bonding gap BG1 designed. The second rendering pitch RP2 is the actual interval between the pixels transferring the light of the image to the first viewpoint VW1 through a viewpoint divider 800-2 bonded by a bonding gap BG2 having a size smaller than the designed bonding gap BG1. As a result, the second rendering pitch RP2 is smaller than the first rendering pitch RP1. When the display panel 300 displays the three-dimensional image according to the original design without considering the error of the bonding gap BG, a crosstalk phenomenon in which the left-eye image and the right-eye image appear mixed may occur (i.e., when both left-eye and right-eye images are visible by the same eye).

The foregoing bonding error between the display panel 300 and the viewpoint divider 800 may be actually measured by measurement equipment. For example, a luminance meter may measure the offsets offset1 and offset2 in which the viewpoint divider 800 deviates in the x-axis direction and the y-axis direction, respectively, the viewpoint division slope SL including the rotation error of the viewpoint divider 800, the bonding gap BG between the display panel 300 and the viewpoint divider 800, and the like while the display panel 300 displays an image of a specific pattern. The measurement may be performed after the display panel 300 is bonded to the viewpoint divider 800 in the process of manufacturing the three-dimensional image display device. The bonding error between the display penal 300 and the viewpoint divider 800 may be measured by various equipments and methods, and the present disclosure is not limited to the equipment and method.

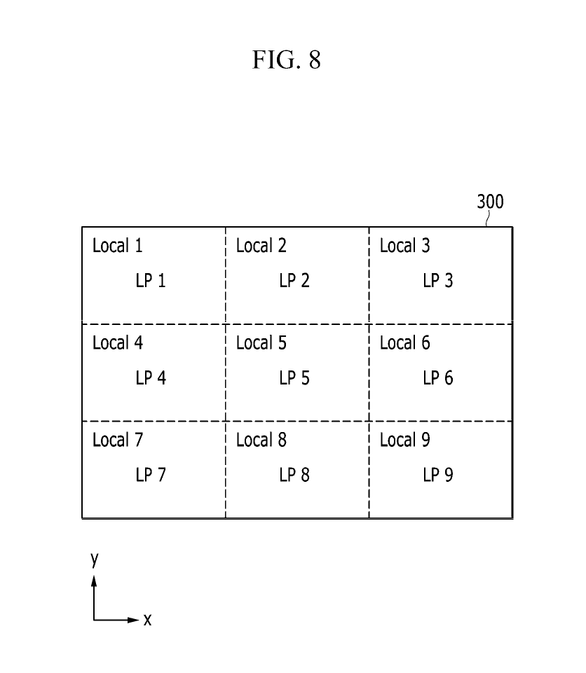

The measured bonding error between the display panel 300 and the viewpoint divider 800 is a parameter for the alignment between the display panel 300 and the viewpoint divider 800 and is stored in the parameter storage unit 360. The parameters stored in the parameter storage unit 360 are described with reference to FIG. 8.

FIG. 8 is an exemplified diagram for describing an example of the parameters stored in the parameter storage unit of the three-dimensional image display device according to an exemplary embodiment of the present disclosure.

Referring to FIG. 8, the parameters for the alignment between the display panel 300 and the viewpoint divider 800 includes a design parameter representing the design value of the alignment between the display panel 300 and the viewpoint divider 800 and a measurement parameter representing the measurement value of the alignment between the display panel 300 and the viewpoint divider 800. That is, the parameter storage unit 360 may store the design parameter and the measurement parameter.

The design parameter includes the viewpoint division pitch P when the display panel 300 is accurately bonded to the viewpoint divider 800 according to the design value, the bonding gap BG between the display panel 300 and the viewpoint divider 800, the viewpoint division slope SL, the optimal viewing distance OVD, the rendering pitch RP, or the like. In the design parameter, the viewpoint division pitch P for the entire area of the display panel 300, the bonding gap BG between the display panel 300 and the viewpoint divider 800, the viewpoint division slope SL, the optimal viewing distance OVD, the rendering pitch RP may each have one value.

The measurement parameter includes the offsets offset1 and offset2 of the viewpoint divider 800, the viewpoint division slope SL, the bonding gap BG between the display panel 300 and the viewpoint divider 800, and the like, which are measured after the display panel 300 is bonded to the viewpoint divider 800 in the process of manufacturing the three-dimensional image display device. The measurement parameter may include the offsets offset1 and offset 2, the viewpoint division slope SL, and the bonding gap BG, which are measured for each of a plurality of areas Local1, . . . , Local9 of the display panel 300. That is, the display panel 300 is divided into the plurality of areas Local1, . . . , Local9, and the offsets offset1 and offset 2, the viewpoint division slope SL, and the bonding gap BG for each area are measured. Thereafter, a plurality of measurement parameters LP1 and LP9 corresponding to the plurality of areas Local1, . . . , Local9, respectively, may be stored in the parameter storage unit 360.

Measuring each measurement parameter by dividing the display panel 300 into nine areas Local1, . . . , Local9 is exemplified herein, but the present disclosure is not limited thereto. Therefore, the display panel 300 may be divided into greater or smaller numbers of areas, and a measurement parameter of each area may be stored in the parameter storage unit 360.

Further, although the offset of the viewpoint divider 800 is described above as having the first offset offset1 in which the viewpoint divider 800 deviates in the x-axis direction and the second offset offset2 in which the viewpoint divider 800 deviates in the y-axis direction, it is only an example. In another embodiment, for example, only one offset representing the moving distance of the lenticular lens 810 or the opening 820 of the parallax barrier of the viewpoint divider 800 in the x-axis direction may be measured and stored in the parameter storage unit 360.

The rendering pitch RP calculated from the measurement parameters of each area may also be stored in the parameter storage unit 360.

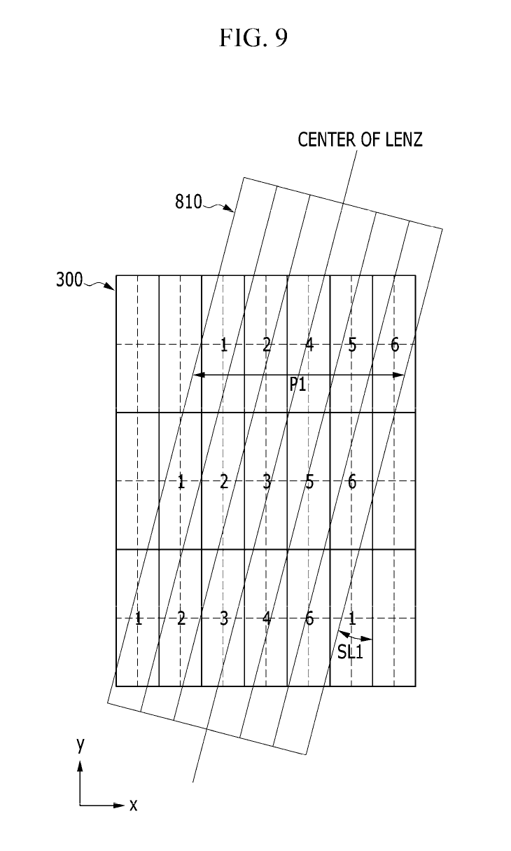

Hereinafter, a process of compensating for the misalignment between display panel 300 and the viewpoint divider 800 using the parameter for the alignment between the display panel 300 and the viewpoint divider 800 is described with reference to FIGS. 9 to 11.

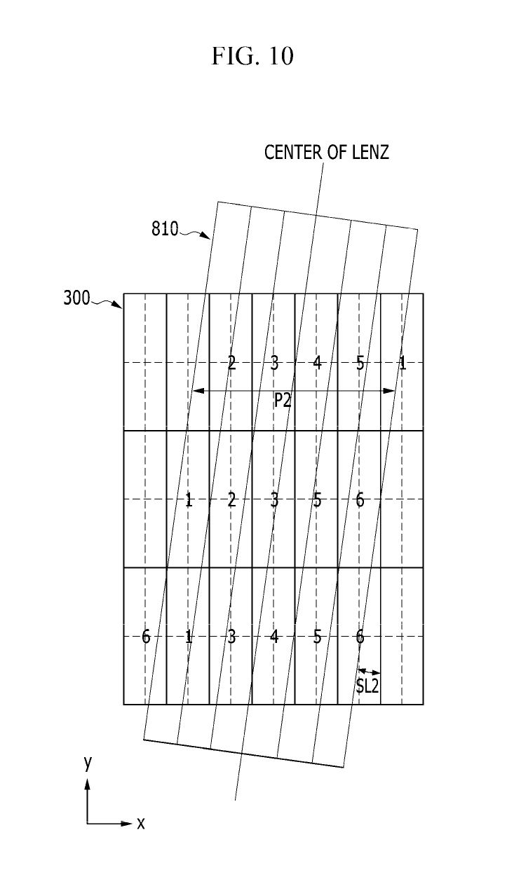

FIGS. 9 and 10 are exemplified diagrams for describing the process of compensating for the slope of the viewpoint divider of the three-dimensional image display device according to exemplary embodiments of the present disclosure. The example in which the viewpoint divider 800 includes the plurality of lenticular lenses 810 will be described.

FIG. 9 illustrates a first viewpoint division slope SL1 of the lenticular lens 810 of the viewpoint divider 800 when the display panel 300 is accurately bonded to the viewpoint divider 800 according to the design value. FIG. 10 illustrates a second viewpoint division slope SL2 resulting from the bonding error between the display panel 300 and the viewpoint divider 800.

The first viewpoint division slope SL1 of FIG. 9, which is a design value, may be stored in the parameter storage unit 360 as the design parameter. Further, the first viewpoint division pitch P1 corresponding to the first viewpoint division slope SL1 is also a design value and may be stored in the parameter storage unit 360 as the design parameter.

The second viewpoint division slope SL2 of FIG. 10 is a measured value, which may be different from the design value, and may be stored in the parameter storage unit 360 as the measurement parameter. When the second viewpoint division slope SL2 is different from the design value (i.e., SL1), the second viewpoint division pitch P2 in the x-axis direction is also different from the design value (i.e., P1). The second viewpoint division pitch P2 may be calculated based on a correlation among the first viewpoint division slope SL1, the first viewpoint division pitch P1, and the measured second viewpoint division slope SL2, which are stored in the parameter storage unit 360. When the second viewpoint division pitch P2 is different from the design value, the actual rendering pitch also differs from its design value.

A central position of the lenticular lens 810 (or central position of the opening 820 of the parallax barrier) may be calculated by reflecting the first offset offset1 and the second offset offset2, which are stored in the parameter storage unit 360, or the offset representing the moving distance of the lenticular lens 810 (or the opening 820 of the parallax barrier) of the viewpoint divider 800 in the x-axis direction.

The pixel mapping is performed according to the changed rendering pitch (i.e., the actual value of the rendering pitch, which may be different from its design value), the second viewpoint division slope SL2 and the central position of the lenticular lens 810 (or central position of the opening 820 of the parallax barrier).

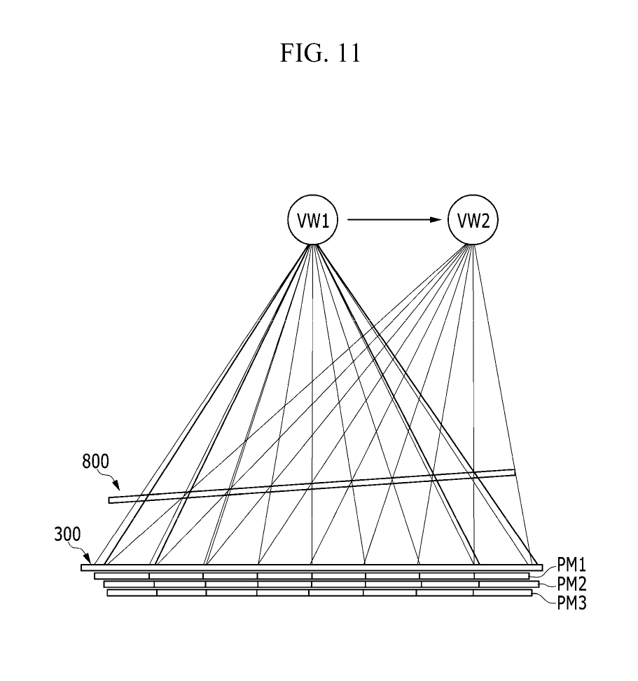

FIG. 11 is an exemplified diagram for describing the process of compensating for the bonding gap between the display panel and the viewpoint divider of the three-dimensional image display device according to an exemplary embodiment of the present disclosure.

FIG. 11 illustrates that the bonding gap BG between the display panel 300 and the viewpoint divider 800 is not formed at a constant thickness and is formed differently from the design value.

If the pixel mapping in display panel 300 is performed on the first viewpoint VW1 like PM1 in the case in which the display panel 300 is accurately bonded to the viewpoint divider 800 according to the design value, the pixel mapping in the display panel 300 is performed on the first viewpoint VW1 like PM2 by applying the rendering pitch calculated based on the measured bonding gap BG when the bonding gap BG is formed at a thickness that is not constant as illustrated.

Further, when the user's viewpoint is changed from the first viewpoint VW1 to the second viewpoint VW2, the rendering pitch is calculated based on the measured bonding gap BG and the second viewpoint VW2, and the pixel mapping in the display panel 300 is performed on the second viewpoint VW2 like PM3 by applying the calculated rendering pitch.

As described above, the changed rendering pitch, with respect to its design value, is calculated by using each offset of the plurality of areas Local1, . . . , Local9, the viewpoint division slope SL, and the bonding gap of the display panel 300, which are stored in the parameter storage unit 360, and the pixel mapping is performed by applying the calculated rendering pitch, thereby compensating for the misalignment between the display panel 300 and the viewpoint divider 800.

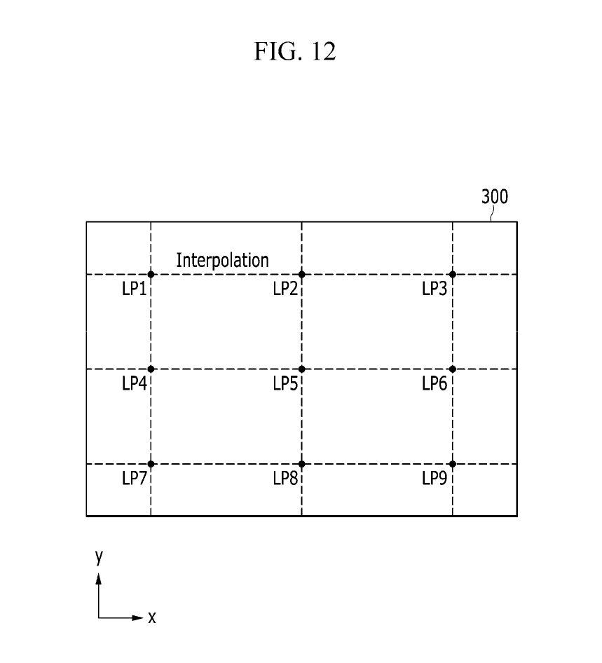

FIG. 12 is an exemplified diagram for describing another example of parameters stored in the parameter storage unit of the three-dimensional image display device according to an exemplary embodiment of the present disclosure.

As illustrated in FIG. 8, a boundary part may be visualized due to a difference between the measurement parameters of each area Local1, . . . , Local9 by applying the measurement parameters for each of the plurality of areas Local1, . . . , Local9 of the display panel 300 to calculate the rendering pitch and compensating for the misalignment between the display panel 300 and the viewpoint divider 800.

As illustrated in FIG. 12, the image processor 500 may define the measurement parameters LP1, . . . , LP9 for each of the plurality of areas as the central values of each area and calculate additional parameters by interpolating between the central values of the measurement parameters LP1, . . . , LP9 for each area. It is possible to prevent the boundary part between the respective areas from being visualized by applying the additional parameters to calculate the rendering pitch and compensating for the misalignment between the display panel 300 and the viewpoint divider 800. In other words, the appearance of boundaries among the plurality of areas when displaying an image may be prevented or smoothed out by applying interpolation to calculate the additional parameters. In this case, interpolation resolution may be controlled.

The accompanying drawings and the detailed description of the present disclosure provide examples of the teachings herein and do not limit the meaning or the scope of the appended claims. Therefore, it will be appreciated to those skilled in the art that various modifications may be made and that other equivalent embodiments are available.

While the present system and method have been described in connection with exemplary embodiments, it is to be understood that the present system and method are not limited to the disclosed embodiments. On the contrary, the present system and method cover various modifications and equivalent arrangements included within the spirit and scope of the appended claims.

### DESCRIPTION OF SYMBOLS

300: Display panel

350: Display panel driver

360: Parameter storage unit

370: Sensor unit

500: Image processor

800: Viewpoint divider

850: Viewpoint division driver

What is claimed is:

1. A three-dimensional image display device, comprising:
a display panel including a plurality of signal lines and a plurality of pixels connected to the plurality of signal lines;
a viewpoint divider configured to divide an image displayed by the display panel into a plurality of viewpoints;
a parameter storage unit configured to store parameters for an alignment between the display panel and the viewpoint divider;
an image processor configured to:
calculate a rendering pitch according to the alignment between the display panel and the viewpoint divider by using the parameters stored in the parameter storage unit, and
generate an image signal to perform pixel mapping according to the rendering pitch; and
a display panel driver configured to receive the image signal to drive the display panel.

2. The three-dimensional image display device of claim 1, wherein:
the parameter includes a design parameter representing a design value for the alignment between the display panel and the viewpoint divider and a measurement parameter representing a measurement value of the alignment between the display panel and the viewpoint divider.

3. The three-dimensional image display device of claim 2, wherein:
the design parameter includes at least one of a viewpoint division pitch of the viewpoint divider, a bonding gap between the display panel and the viewpoint divider, a viewpoint division slope of a lenticular lens or an opening included in the viewpoint divider, an optimal viewing distance, and the rendering pitch.

4. The three-dimensional image display device of claim 2, wherein:
the measurement parameter includes a bonded offset representing a movement of the viewpoint divider in an x-axis or y-axis direction with respect to the display panel.

5. The three-dimensional image display device of claim 4, wherein:
the measurement parameter further includes a viewpoint division slope of a lenticular lens or an opening included in the viewpoint divider that represents a rotation of the viewpoint divider around a z-axis with respect to the display panel.

6. The three-dimensional image display device of claim 5, wherein:
the measurement parameter further includes a bonding gap between the display panel and the viewpoint divider.

7. The three-dimensional image display device of claim 6, wherein:
the display panel is divided into a plurality of areas, and
the measurement parameter includes local measurement parameters measured for each of the plurality of areas.

8. The three-dimensional image display device of claim 7, wherein:
the image processor defines the local measurement parameters for each of the plurality of areas as central values of each area and interpolates between the central values to calculate additional parameters.

9. The three-dimensional image display device of claim 7, wherein:
the parameter storage unit is prepared as a storage medium of an EEPROM and is integrated on the display panel along with the display panel driver.

10. The three-dimensional image display device of claim 7, wherein:
the parameter storage unit is prepared as a storage medium of an EEPROM and is mounted on a printed circuit board (PCB) along with the display panel driver.

11. A driving method of a three-dimensional image display device including a display panel including a plurality of signal lines and a plurality of pixels connected to the plurality of signal lines and a viewpoint divider dividing an image displayed by the display panel into a plurality of viewpoints, the driving method comprising:
calculating a rendering pitch according to an alignment between the display panel and the viewpoint divider using parameters for the alignment between the display panel and the viewpoint divider;
generating an image signal to perform pixel mapping according to the rendering pitch; and
driving the display panel according to the image signal.

12. The driving method of claim 11, wherein:
the parameter includes a design parameter representing a design value of the alignment between the display panel and the viewpoint divider and a measurement parameter representing a measurement value of the alignment between the display panel and the viewpoint divider.

13. The driving method of claim 12, wherein:
the design parameter includes at least one of a viewpoint division pitch of the viewpoint divider, a bonding gap between the display panel and the viewpoint divider, a viewpoint division slope of a lenticular lens or an opening included in the viewpoint divider, an optimal viewing distance, and the rendering pitch.

14. The driving method of claim 12, wherein:
the measurement parameter includes a bonded offset representing a movement of the viewpoint divider in an x-axis or y-axis direction with respect to the display panel.

15. The driving method of claim 14, wherein:
the measurement parameter further includes a viewpoint division slope of a lenticular lens or an opening included in the viewpoint divider that represents a rotation of the viewpoint divider around a z-axis with respect to the display panel.

16. The driving method of claim 15, wherein:
the measurement parameter further includes a bonding gap between the display panel and the viewpoint divider.

17. The driving method of claim 16, wherein:
the display panel is divided into a plurality of areas, and
the measurement parameter includes local measurement parameters measured for each of the plurality of areas.

18. The driving method of claim 17, further comprising:
defining the local measurement parameters for each of the plurality of areas as central values of each area and interpolating between the central values to calculate additional parameters.
